(19) United States
(12) Patent Application Publication
(10) Pub. No.: US 2016/0045872 A1
(43) Pub. Date: Feb. 18, 2016

(54) FILTRATION APPARATUS AND METHOD FOR CLEANING FILTRATION MODULE

(71) Applicant: SUMITOMO ELECTRIC INDUSTRIES, LTD., Osaka-shi, Osaka (JP)

(72) Inventor: Hideki KASHIHARA, Osaka-shi (JP)

(73) Assignee: SUMITOMO ELECTRIC INDUSTRIES, LTD., Osaka-shi, Osaka (JP)

(21) Appl. No.: 14/778,679

(22) PCT Filed: Jan. 20, 2014
(86) PCT No.: PCT/JP2014/050968

§ 371 Date: Sep. 21, 2015

(30) Foreign Application Priority Data
Mar. 22, 2013 (JP) 2013-059471

(51) Int. Cl. B01D 65/02; C02F 1/44; B01D 63/04

(52) U.S. Cl. CPC B01D 65/02; B01D 63/04; C02F 1/44; B01D 2321/02; B01D 2321/04; B01D 2321/162; B01D 2321/164; B01D 2321/168; B01D 2321/2025; C02F 2303/16; B01D 2321/2033

(57) ABSTRACT

Provided are a filtration apparatus and a method for cleaning a filtration module in which it is possible to maintain sufficiently high levels of filtration efficiency even when filtration is continued for a long time. A filtration apparatus includes a filtration module having a hollow-fiber membrane bundle in which a plurality of hollow-fiber membranes are bundled together; a filtration vessel that houses the filtration module; and a cleaning device that cleans the filtration module. The cleaning device includes an internal cleaning device which cleans the hollow-fiber membrane bundle from the inside by jetting wash water from the tip of an internal cleaning nozzle inserted into the hollow-fiber membrane bundle so as to generate an internal cleaning flow in the hollow-fiber membrane bundle. A method for cleaning a filtration module uses the filtration apparatus.

### TECHNICAL FIELD

The present invention relates to a filtration apparatus including a filtration module having a hollow-fiber membrane bundle in which a plurality of hollow-fiber membranes are bundled together, and a cleaning device that removes suspended solids adhering to the hollow-fiber membranes by cleaning, and also relates to a method for cleaning a filtration module.

### BACKGROUND ART

In order to remove suspended solids (organic molecules, particulates, oil droplets, organisms such as plankton, transparent exopolymer particles (TEP) secreted extracellularly by bacteria, and the like) contained in seawater, river water, wastewater, oilfield-produced water, and the like, filtration apparatuses, in which a filtration module provided with a hollow-fiber membrane bundle is placed in a vessel, are widely used.

In such filtration apparatuses, raw water (water to be treated) supplied from the outside of the filtration module is allowed to pass from the outer side of hollow-fiber membranes toward the inner hollow portions, and thus filtration is performed.

However, when such filtration apparatuses are used, as filtration continues, the suspended solids adhere to surfaces of the hollow-fiber membranes, thereby clogging the hollow-fiber membranes, which degrades filtration efficiency.

In order to solve such clogging and to maintain high levels of filtration efficiency, for example, a method (backwashing) is generally used in which water is made to flow in a direction opposite to that of filtration so that suspended solids adhering to surfaces of hollow-fiber membranes can be removed.

Furthermore, in order to appropriately remove suspended solids that are difficult to remove by ordinary backwashing, spray cleaning, in which wash water is sprayed at a high pressure to the surface of a hollow-fiber membrane bundle to clean a filtration module, or jet cleaning, in which by jetting wash water from an eductor nozzle or a bubbling jet nozzle, a jet water flow of the wash water is generated in a filtration vessel to clean a filtration module, and the like are performed (for example, refer to PTL 1).

### CITATION LIST

### Patent Literature

PTL 1: International Publication No. 2012/043433

### SUMMARY OF INVENTION

### Technical Problem

However, in the case where filtration is continued for a long time, despite removing suspended solids by spray cleaning or jet cleaning, it is not possible to maintain sufficiently high levels of filtration efficiency, which is a problem.

Accordingly, it is an object of the present invention to provide a filtration apparatus and a method for cleaning a filtration module in which it is possible to maintain sufficiently high levels of filtration efficiency even when filtration is continued for a long time.

### Solution to Problem

The present inventor has performed thorough studies in order to solve the problem described above. It has been studied, in the case of existing filtration apparatuses, why it is not possible to maintain sufficiently high levels of filtration efficiency.

As a result, it has been found that, in the case of existing filtration apparatuses, since hollow-fiber membranes located on the inner side of a hollow-fiber membrane bundle are not sufficiently cleaned, it is not possible to maintain sufficiently high levels of filtration efficiency.

That is, a hollow-fiber membrane bundle is formed by bundling together a plurality of hollow-fiber membranes. Even when spray cleaning or jet cleaning is performed on the surface of the hollow-fiber membrane bundle, although hollow-fiber membranes located on the outer side of the hollow-fiber membrane bundle can be cleaned, a sufficient amount of wash water is not supplied to hollow-fiber membranes located inside, and therefore, suspended solids cannot be removed sufficiently. Thus, unremoved soil are likely to remain inside the hollow-fiber membrane bundle.

As filtration continues, unremoved soil inside the hollow-fiber membrane bundle gradually accumulate. Therefore, even if cleaning is performed, it is difficult to maintain sufficiently high levels of filtration efficiency.

Accordingly, the present inventor has performed various experiments and studies on methods for preventing the occurrence of very small amounts of unremoved soil inside such a hollow-fiber membrane bundle. As a result, it has been confirmed that, in the case where an internal cleaning nozzle is inserted into the hollow-fiber membrane bundle, and wash water is jetted from the internal cleaning nozzle to generate an internal cleaning flow in the hollow-fiber membrane bundle, the hollow-fiber membrane bundle can be appropriately cleaned from the inside, and it is possible to prevent the occurrence of unremoved soil. Thus, the present invention has been completed.

According to a first embodiment of the present invention, which is an invention based on the finding described above, a filtration apparatus includes a filtration module having a hollow-fiber membrane bundle in which a plurality of hollow-fiber membranes are bundled together; a filtration vessel that houses the filtration module; and a cleaning device that cleans the filtration module. The cleaning device includes an internal cleaning device which cleans the hollow-fiber membrane bundle from the inside by jetting wash water from the tip of an internal cleaning nozzle inserted into the hollow-fiber membrane bundle so as to generate an internal cleaning flow in the hollow-fiber membrane bundle.

By providing such an internal cleaning device, suspended solids adhering to the hollow-fiber membranes inside the hollow-fiber membrane bundle can be efficiently removed. Therefore, even when filtration is continued for a long time, sufficiently high levels of filtration efficiency can be maintained.

According to a second embodiment of the present invention, in the filtration apparatus according to the first embodiment of the present invention, the internal cleaning nozzle is an orthogonal nozzle that is inserted perpendicular to the longitudinal direction of the hollow-fiber membrane bundle and provided with a jet orifice at the tip thereof, the jet orifice jetting the wash water along the longitudinal direction of the hollow-fiber membrane bundle.

By providing such an orthogonal nozzle as the internal cleaning nozzle, the wash water can be sufficiently supplied over the entire length of the hollow-fiber membranes located inside the hollow-fiber membrane bundle, and therefore, cleaning efficiency can be further improved.

According to a third embodiment of the present invention, in the filtration apparatus according to the first or second embodiment of the present invention, the cleaning device includes, in addition to the internal cleaning device, an external cleaning device which cleans the hollow-fiber membrane bundle from the outside by jetting wash water from the tip of an external cleaning nozzle provided, separately from the internal cleaning nozzle, on the inner wall surface of the filtration vessel so as to generate a whirling cleaning flow that whirls around the hollow-fiber membrane bundle.

In this embodiment of the present invention, since the whirling cleaning flow, in addition to the internal cleaning flow, is generated, the distance between the hollow-fiber membranes constituting the hollow-fiber membrane bundle is increased by the internal cleaning flow, and the whirling cleaning flow penetrates the inside of the hollow-fiber membrane bundle. Thereby, the hollow-fiber membranes are each washed by rubbing, and suspended solids can be removed from the inside and outside of the hollow-fiber membrane bundle.

As the external cleaning nozzle that generates a whirling cleaning flow, for example, an eductor nozzle or bubbling jet nozzle that generates a jet water flow is preferably used.

According to a fourth embodiment of the present invention, in the filtration apparatus according to the third embodiment of the present invention, the external cleaning nozzle is a slanting nozzle that passes through the wall surface of the filtration vessel, is inclined and fixed at a predetermined angle with respect to the longitudinal direction of the hollow-fiber membrane bundle, and is provided with a jet orifice at the tip thereof, the jet orifice jetting the wash water along the inner wall surface of the filtration vessel.

By using a slanting nozzle that is inclined and fixed at a predetermined angle as the external cleaning nozzle, a whirling cleaning flow can be easily generated in the filtration apparatus.

According to a fifth embodiment of the present invention, a method for cleaning a filtration module by using the filtration apparatus according to any one of the first to fourth embodiments of the present invention, includes cleaning the hollow-fiber membrane bundle from the inside by jetting wash water from the tip of the internal cleaning nozzle so as to generate an internal cleaning flow in the hollow-fiber membrane bundle.

As described above, by cleaning the hollow-fiber membrane bundle from the inside using an internal cleaning flow, suspended solids adhering to the hollow-fiber membranes inside the hollow-fiber membrane bundle can be efficiently removed.

According to a sixth embodiment of the present invention, in the method for cleaning a filtration module according to the fifth embodiment of the present invention, the filtration module is cleaned using, as the wash water, wash water obtained by adding any agent selected from the group consisting of an acid, an alkali, a hypochlorite, and a detergent to water.

By using the wash water obtained by adding any agent selected from the group consisting of an acid, an alkali, a hypochlorite, and a detergent to water, the cleaning effect can be further improved.

In an existing filtration apparatus, in the case where filtration efficiency decreases, the filtration efficiency is recovered by detaching a filtration module from the filtration apparatus and immersing the filtration module in an aqueous solution of any of the agents described above for a predetermined time (for example, about half a day).

In contrast, in the filtration apparatus according to the present invention, by using, as the wash water, an aqueous solution to which any of the agents is added, suspended solids can be appropriately removed even without performing the immersion treatment described above. Therefore, the time and cleaning costs associated with detachment and attachment of the filtration module and immersion can be effectively reduced. Furthermore, the amount of the agent used can be decreased.

According to a seventh embodiment of the present invention, in the method for cleaning a filtration module according to the sixth embodiment of the present invention, the acid is citric acid, the alkali is sodium hydroxide, the hypochlorite is sodium hypochlorite, and the detergent is limonene.

These agents have been used as an appropriate agent for removing suspended solids adhering to hollow-fiber membranes and therefore are easily available, and no new consideration is required for use.

Specifically, by using citric acid as the acid, cleaning efficiency with respect to various suspended solids in general can be improved. Furthermore, by using sodium hydroxide as the alkali, cleaning efficiency with respect to inorganic suspended solids, such as sand and stones, can be particularly improved. By using sodium hypochlorite as the hypochlorite, cleaning efficiency with respect to organic suspended solids derived from bacteria and plankton can be particularly improved. Furthermore, by using limonene (orange oil) as the detergent, TEP can be decomposed and cleaned suitably.

According to an eighth embodiment of the present invention, in the method for cleaning a filtration module according to the seventh embodiment of the present invention, the filtration module is cleaned by varying types of wash water in the order of the wash water added with sodium hypochlorite, the wash water added with sodium hydroxide, and the wash water added with citric acid.

As described above, sodium hypochlorite, sodium hydroxide, and citric acid can remove different suspended solids. By varying types of wash water in the order described above and performing cleaning for different suspended solids in sequence, the cleaning efficiency can be further improved.

According to a ninth embodiment of the present invention, in the method for cleaning a filtration module according to the seventh or eighth embodiment of the present invention, the wash water added with citric acid and the wash water added with sodium hydroxide are mixed and neutralized before being discharged.

By mixing the used wash water added with citric acid and the used wash water added with sodium hydroxide, it is not necessary to perform neutralization treatment that is required when wash water added with an agent is disposed of, which can contribute to a reduction in cleaning costs.

According to a tenth embodiment of the present invention, in the method for cleaning a filtration module according to any one of the sixth to ninth embodiments of the present invention, the filtration module is cleaned by circulating the wash water between a storage tank that stores the wash water added with the agent and the filtration vessel.

By circulating the wash water added with the agent between the storage tank and the filtration vessel, the agent can be efficiently used. Therefore, the amount of the agent used can be further decreased, and the cleaning costs can be further reduced.

### Advantageous Effects of Invention

According to the present invention, it is possible to provide a filtration apparatus and a method for cleaning a filtration module in which sufficiently high levels of filtration efficiency can be maintained even when filtration is continued for a long time.

### BRIEF DESCRIPTION OF DRAWINGS

FIG. 1 is a schematic view showing a filtration apparatus according to an embodiment of the present invention.

FIG. 2 is a side view showing an appearance of the filtration apparatus according to the embodiment of the present invention.

FIG. 3 is a diagram illustrating operations of the filtration apparatus shown in FIG. 1.

FIG. 4 is a schematic view showing a specific cleaning method using a filtration apparatus according to an embodiment of the present invention.

### DESCRIPTION OF EMBODIMENTS

Embodiments of the present invention will be described below with reference to the drawings.

1. General Description of Filtration Apparatus and Cleaning of Filtration Module

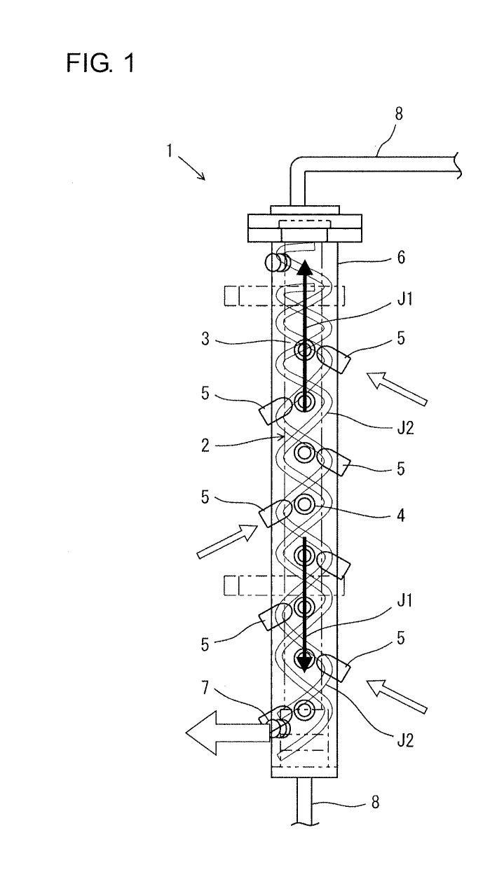

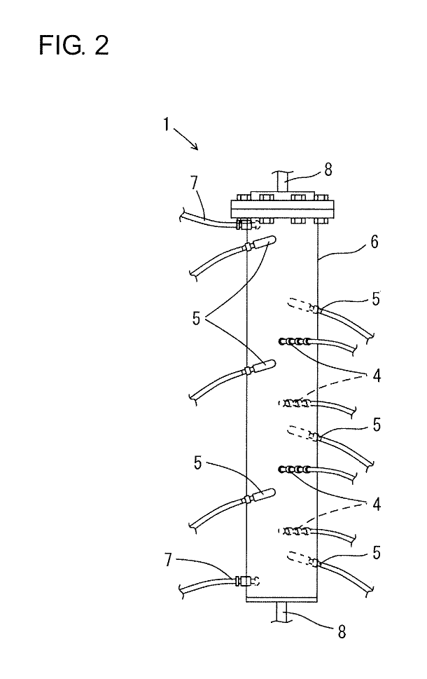

First, a filtration apparatus according to an embodiment of the present invention will be described. FIG. 1 is a view illustrating a filtration apparatus according to the embodiment, and FIG. 2 is a side view showing an appearance of the filtration apparatus according to the embodiment.

As shown in FIGS. 1 and 2, a filtration apparatus 1 according to the embodiment includes a filtration module 2 having a hollow-fiber membrane bundle 3 in which a plurality of hollow-fiber membranes are bundled together, and a filtration vessel 6 that houses the filtration module 2. In the drawings, reference sign 7 designates a raw water inflow tube, and reference sign 8 designates a filtrate outflow tube.

The filtration apparatus 1 according to the embodiment is different from an existing filtration apparatus in that it includes, in addition to the structure described above, an internal cleaning device which cleans the filtration module 2 from the inside.

The internal cleaning device cleans the filtration module 2 from the inside of the hollow-fiber membrane bundle 3 by jetting wash water along the longitudinal direction of the hollow-fiber membrane bundle 3 from a jet orifice provided on the tip of each internal cleaning nozzle (orthogonal nozzle) 4 inserted into the hollow-fiber membrane bundle 3 perpendicular to the longitudinal direction of the hollow-fiber membrane bundle 3 so as to generate an internal cleaning flow J1 vertically in the hollow-fiber membrane bundle 3.

Furthermore, the filtration apparatus 1 according to the embodiment includes an external cleaning device which cleans the filtration module 2 from the outside of the hollow-fiber membrane bundle 3 by jetting wash water from the tip of each external cleaning nozzle (slanting nozzle) 5 provided on the wall surface of the filtration vessel 6 so as to generate a whirling cleaning flow J2 that whirls around the hollow-fiber membrane bundle 3.

The slanting nozzle 5 passes through the wall surface of the filtration vessel 6, is inclined and fixed at a predetermined angle (e.g., 5° to 45°) with respect to the longitudinal direction of the hollow-fiber membrane bundle 3, and is provided with a jet orifice at the tip thereof, the jet orifice jetting wash water along the inner wall surface of the filtration vessel 6. Thereby, the whirling cleaning flow J2 can be easily generated.

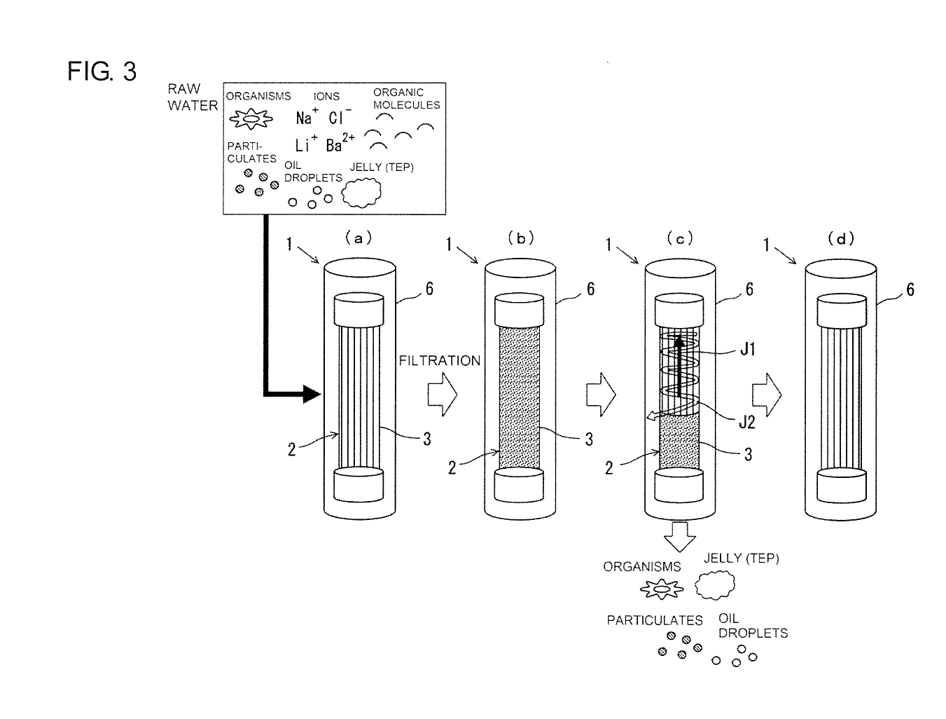

Next, operations of the filtration apparatus according to the embodiment will be described with reference to FIGS. 1 to 3. FIG. 3 is a schematic diagram showing the operations of the filtration apparatus.

In the filtration apparatus 1 according to the embodiment, during a normal filtration operation, raw water containing suspended solids, such as organisms, particulates, oil droplets, and TEP, is made to flow into the filtration vessel 6 from an inflow tube 7 (refer to FIGS. 1 and 2) and passed through each of hollow-fiber membranes of the hollow-fiber membrane bundle 3 constituting the filtration module 2 from the outer surface side toward the inner surface side of the hollow fiber membrane, and the suspended solids are left on the surface of the hollow-fiber membrane. In such a manner, raw water is filtrated. The filtrate moves through inner cavities of the hollow-fiber membranes along the longitudinal direction of the hollow-fiber membrane bundle 3 and is made to flow out from the outflow tube 8 (refer to FIG. 3(a)).

As described above, the suspended solids adhere to the surfaces of the hollow-fiber membranes. Therefore, as the filtration operation continues, the hollow-fiber membranes are clogged by the suspended solids (refer to FIG. 3(b)).

In the case where clogging occurs as described above, first, with the raw water inflow tube 7 being open to the outside, the outflow tube 8 of the filtrate is sealed, and then wash water is jetted from the orthogonal nozzles 4 and the slanting nozzles 5.

At this time, as shown in FIGS. 1 and 3(c), since the wash water is jetted from the orthogonal nozzles 4, an internal cleaning flow J1 is generated in the hollow-fiber membrane bundle 3 along the longitudinal direction of the hollow-fiber membrane bundle 3. Accordingly, the hollow-fiber membrane bundle 3 is appropriately cleaned from the inside.

On the other hand, since the wash water is jetted from the slanting nozzles 5, a whirling cleaning flow J2 that whirls around the hollow-fiber membrane bundle 3 is generated in the filtration vessel 6. Accordingly, the hollow-fiber membrane bundle 3 is cleaned from the outside.

Furthermore, with the generation of the internal cleaning flow J1, the distance between the hollow-fiber membranes increases, and the hollow-fiber membrane bundle 3 expands. Therefore, the whirling cleaning flow J2 penetrates the hollow-fiber membrane bundle 3 through expanded gaps of the hollow-fiber membrane bundle 3 and, in cooperation with the internal cleaning flow J1, performs cleaning such that the hollow-fiber membranes are each washed by rubbing.

The wash water containing suspended solids which have been removed from the outer surfaces of the hollow-fiber membranes by the internal cleaning flow J1 and the whirling cleaning flow J2 is discharged from the raw water inflow tube 7 which is open to the outside. This recovers the filtration capability (differential pressure between front and rear sides of hollow-fiber membranes) of the filtration apparatus 1, and the filtration operation is resumed (refer to FIG. 3(d)).

In the filtration apparatus 1 according to the embodiment, the internal cleaning flow J1 is generated in the hollow-fiber membrane bundle 3, and the hollow-fiber membrane bundle 3 is appropriately cleaned from the inside. Therefore, it is possible to prevent unremoved soil from remaining inside the hollow-fiber membrane bundle 3.

Furthermore, by generating the internal cleaning flow J1 and the whirling cleaning flow J2 simultaneously, a cleaning flow is generated such that the hollow-fiber membranes are each washed by rubbing. Therefore, each of the hollow-fiber membranes constituting the hollow-fiber membrane bundle 3 can be appropriately cleaned without leaving unremoved soil.

As described above, in the filtration apparatus according to the embodiment, suspended solids adhering not only to hollow-fiber membranes located on the outer side of the hollow-fiber membrane bundle, but also to hollow-fiber membranes located on the inner side of the hollow-fiber membrane bundle can be appropriately removed. Therefore, high levels of filtration efficiency can be maintained for a longer time than existing filtration apparatuses.

2. Specific Cleaning Method

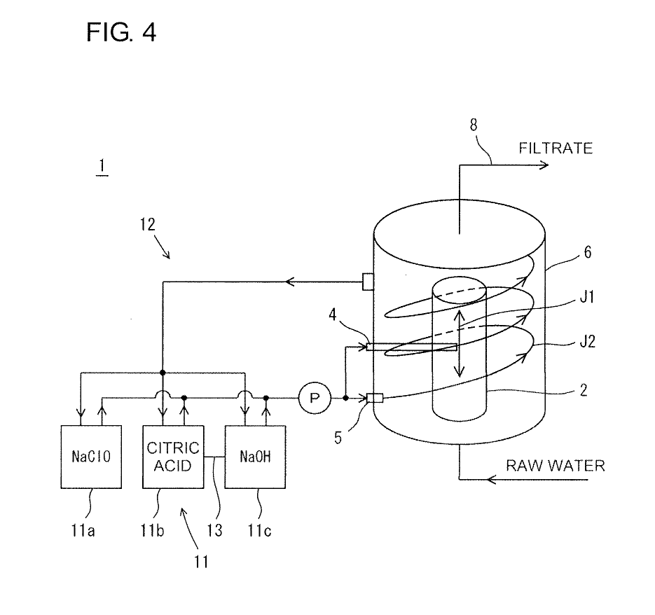

An example of a specific method for cleaning a filtration module using the filtration apparatus shown in the embodiment described above will be described with reference to FIG. 4.

In this embodiment, as the wash water that cleans a filtration module 2, wash water obtained by adding any agent selected from the group consisting of an acid, an alkali, a hypochlorite, and a detergent to water is used.

Specifically, as shown in FIG. 4, a filtration apparatus 1 includes a chemical injection device (not shown) that adds an agent to the wash water, a storage tank 11 that stores the wash water added with the agent, and a wash water circulation line 12 that circulates the wash water added with the agent between the storage tank 11 and the filtration vessel 6.

Furthermore, the storage tank 11 includes a NaClO tank 11a that stores the wash water added with sodium hypochlorite, a citric acid tank 11b that stores the wash water added with citric acid, and a NaOH tank 11c that stores the wash water added with sodium hydroxide.

The storage tanks 11a, 11b, and 11c are each connected to an orthogonal nozzle 4 and a slanting nozzle 5 through a water supply pipe. By switching the connection of the water supply pipe and operating a pump P, the wash water added with any of the agents can be jetted from the orthogonal nozzle 4 and the slanting nozzle 5 into the filtration vessel 6.

Furthermore, the citric acid tank 11b and the NaOH tank 11c are connected to each other through a drain pipe 13.

In the filtration apparatus 1, when clogging occurs in hollow-fiber membranes owing to adhesion of suspended solids, first, by supplying the wash water added with sodium hypochlorite from the NaClO tank 11a to the orthogonal nozzle 4 and the slanting nozzle 5, the filtration module 2 is cleaned. Thus, organic suspended solids adhering to the hollow-fiber membranes are removed.

At this time, the used wash water is discharged from the filtration vessel 6 to the wash water circulation line 12 and supplied to the NaClO tank 11a through the wash water circulation line 12 for reuse.

Next, in the order of the NaOH tank 11c and the citric acid tank 11b, the wash water added with the corresponding agent is jetted from the orthogonal nozzle 4 and the slanting nozzle 5. Thus, inorganic suspended solids, such as sand and stones, adhering to the hollow-fiber membranes are removed.

Regarding these types of wash water, as in the wash water added with sodium hypochlorite, the used water is supplied through the wash water circulation line 12 to the corresponding storage tank 11 for reuse.

Furthermore, when the cleaning operation is finished, a valve of the drain pipe 13 connecting the citric acid tank 11b and the NaOH tank 11c is opened, and citric acid and sodium hydroxide are neutralized before being discharged. Therefore, it is not necessary to separately neutralize the agents added to wash water.

Furthermore, as an agent to be added to wash water, a detergent may be used. As the detergent, limonene, which is suitable for decomposing and cleaning TEP, is particularly preferably used.

The present invention has been described on the basis of embodiments. It is to be noted that the present invention is not limited to the embodiments described above, and various modifications can be made to the embodiments described above within the scope that is the same as and equivalent to that of the present invention.

### REFERENCE SIGNS LIST

1 filtration apparatus

2 filtration module

3 hollow-fiber membrane bundle

4 orthogonal nozzle (internal cleaning nozzle)

5 slanting nozzle (external cleaning nozzle)

6 filtration vessel

7 inflow tube

8 outflow tube

11 storage tank

11a NaClO tank

11b citric acid tank

11c NaOH tank

12 wash water circulation line

13 drain pipe

J1 internal cleaning flow

J2 whirling cleaning flow

P pump

1. A filtration apparatus comprising:
a filtration module having a hollow-fiber membrane bundle in which a plurality of hollow-fiber membranes are bundled together;
a filtration vessel that houses the filtration module; and
a cleaning device that cleans the filtration module,
wherein the cleaning device includes an internal cleaning device which cleans the hollow-fiber membrane bundle from the inside by jetting wash water from the tip of an internal cleaning nozzle inserted into the hollow-fiber membrane bundle so as to generate an internal cleaning flow in the hollow-fiber membrane bundle.

2. The filtration apparatus according to claim 1, wherein the internal cleaning nozzle is an orthogonal nozzle that is inserted perpendicular to the longitudinal direction of the hollow-fiber membrane bundle and provided with a jet orifice at the tip thereof, the jet orifice jetting the wash water along the longitudinal direction of the hollow-fiber membrane bundle.

3. The filtration apparatus according to claim 1, wherein the cleaning device includes, in addition to the internal cleaning device, an external cleaning device which cleans the hollow-fiber membrane bundle from the outside by jetting wash water from the tip of an external cleaning nozzle provided, separately from the internal cleaning nozzle, on the inner wall surface of the filtration vessel so as to generate a whirling cleaning flow that whirls around the hollow-fiber membrane bundle.

4. The filtration apparatus according to claim 3, wherein the external cleaning nozzle is a slanting nozzle that passes through the wall surface of the filtration vessel, is inclined and fixed at a predetermined angle with respect to the longitudinal direction of the hollow-fiber membrane bundle, and is provided with a jet orifice at the tip thereof, the jet orifice jetting the wash water along the inner wall surface of the filtration vessel.

5. A method for cleaning a filtration module by using the filtration apparatus according to claim 1, the method comprising cleaning the hollow-fiber membrane bundle from the inside by jetting wash water from the tip of the internal cleaning nozzle so as to generate an internal cleaning flow in the hollow-fiber membrane bundle.

6. The method for cleaning a filtration module according to claim 5, wherein the filtration module is cleaned using, as the wash water, wash water obtained by adding any agent selected from the group consisting of an acid, an alkali, a hypochlorite, and a detergent to water.

7. The method for cleaning a filtration module according to claim 6, wherein the acid is citric acid, the alkali is sodium hydroxide, the hypochlorite is sodium hypochlorite, and the detergent is limonene.

8. The method for cleaning a filtration module according to claim 7, wherein the filtration module is cleaned by varying types of wash water in the order of the wash water added with sodium hypochlorite, the wash water added with sodium hydroxide, and the wash water added with citric acid.

9. The method for cleaning a filtration module according to claim 7, wherein the wash water added with citric acid and the wash water added with sodium hydroxide are mixed and neutralized before being discharged.

10. The method for cleaning a filtration module according to claim 6, wherein the filtration module is cleaned by circulating the wash water between a storage tank that stores the wash water added with the agent and the filtration vessel.
